(19) United States
(12) Patent Application Publication
(10) Pub. No.: US 2013/0138582 A1
(43) Pub. Date: May 30, 2013

(54) Process of facilitating interaction between people at various locations or events assembled with or without a specific purpose

(71) Applicant: Juhl Khan, Parsippany, NJ (US)

(72) Inventor: Juhl Khan, Parsippany, NJ (US)

(21) Appl. No.: 13/356,689

(22) Filed: Jan. 24, 2012

(30) Foreign Application Priority Data
Nov. 24, 2011 (IN) 3363/MUM/2011

(51) Int. Cl. G06Q 90/00; G09F 21/00

(52) U.S. Cl. 705/500; 40/584

(57) ABSTRACT

The disclosed invention addresses a very unique problem and provides a format of interaction to assist people to effectively interact in any situation through an embodiment of a mark, which is situated in any type of location or event where people assemble, with strangers. The mark may be a symbol, a script or a logo or a combination of any or all of these. The mark may be displayed on electronic display means possibly with remote accessibility. The mark may be accessed through a web site to locate the position of the mark at any location in any country in any location where people tend to group normally. The actual design of the mark will be as authorised and can change upon authorisation by inventor. However, the mark may be used for display only by users which are authorised.

### RELATED APPLICATION

This application claims priority to Indian Application No. 3363/MUM/2011 filed Nov. 24, 2011, which is incorporated herein by reference.

### FIELD OF INVENTION

The present invention provides a novel format of the process of interaction between people at restaurants, events or any other gathering of people not necessarily of a specific type, assembled with or without a specific purpose.

Particularly the present invention provides a mark to provide the novel format of the invention.

More particularly the mark is embodied as a physical object, electronic or non-electronic or as other types of embodiments.

Still more particularly the novel mark may be accessed remotely from an electronic device connected by any communication means.

### BACKGROUND OF INVENTION

Information exchange among people worldwide has increased manifold after the revolution in electronics industry with the astronomical developments in communication technology, high speed data processing, complex data format exchanges, like audio/video etc. However, in person interaction can never be given up as it is the best way of information exchange. People gather around in many situations like in shopping malls, eateries, airports, any social gatherings. During all these gatherings, though people interact on many aspects, they may not at times really know how to go beyond just meeting people already known to them to get the real benefit of being a part of a gathering of any nature at any place. Not only this, at times people may have a specific need of information which is not available online or at any designated space or office and can only be obtained from interaction with local or common people. The present invention provides a solution to all such problems which a person or a group of persons may face at any place or time or any aspect of their daily life.

People can and have been interacting through modern day internet by means of Skype, Facebook, LinkedIn, Orkut, Twitter etc., the so called networking sites. These are all virtual sites and need high technology communication means and computer systems and cell phones with high end applications. These fail when a person or group of persons are in need of a specific help or information which might not be available on the web when they travel from one time zone to another and also when there is a language difference.

Emails are also popular but have the disadvantage of time lag in the event of the contacted group not seeing the mail when required to be seen. The time zone difference and language problems may again crop up in getting the benefit of this facility though invaluable.

US publication number 2006/0277802 A1 discloses a method for encouraging social interaction. This disclosure essentially is meant for a social interaction within a corporate office and is restricted in use by humans. This essentially means that a wearer is required to be present to invite people to interact. Secondly the method is restricted to a tag being applied to a clothing means. The disclosure also encompasses changing of tags to encourage people to interact on specific themes and is not a general tag, which may help people of unknown affiliations to get encouraged to interact.

U.S. Pat. No. 7,942,421 to Melanie Franklin, Antony. H. Lee and Camilo. E. Cucalon discloses a container with messages inside the boxes. The boxes having messages designed to stimulate conversation when a particular subject matter is desired to be discussed. The disclosed invention needs a larger space and is rather inconvenient to be used by people in order to take real advantage of the method of interaction. Additionally, people may have to open boxes and get the real instruction to get to interact with people known or unknown.

US publication 2002/0063686 A1 discloses a method of connecting two individuals by means of internet. The said method uses a sign attached to a window of a vehicle, particularly a car. The said sign is illuminated by the occupant of the car so that the person needing to interact can take down the detail of the occupant and interact on the internet or any other communication means. This disclosure has the limitation of inviting only such people who are on the move in the city and also restricts the interaction by internet means and might not encourage one to one interaction for better social interaction.

An object of the present invention is to provide a novel format of the process of interaction between people at restaurants, events or any other gathering of people not necessarily of a specific type, assembled with or without a specific purpose, which obviates the problems mentioned in the prior art.

Another object of the invention is to provide a mark to provide the novel format of the invention.

A further object of the present invention is to provide a mark, which is a physical object to provide the novel format of the invention.

A further objective of the present invention is to provide a non-electronic physical object mark to provide the novel format of the invention.

A further objective of the invention is to provide a non-electronic physical object mark which is of any regular or irregular geometric configuration to provide the novel format of the invention.

Another object of the invention is to provide inscribed logo, symbol, information/set of information on non-electronic physical object mark to provide the novel format of the invention.

Still further objective of the invention is to provide an electronic mark providing a novel format of the process of interaction between people at restaurants, events or any other gathering of people not necessarily of a specific type, assembled with or without a specific purpose.

An object of the invention is to provide the electronic mark as a display to provide the novel format of the invention.

An object of the invention is to provide an electronic mark accessible remotely by communication means to provide the novel format of the invention.

A still further objective of the present invention is to provide an electronic mark display with logos, cartoons, scripts or any combination of these providing a format of the process of interaction between people at restaurants, events or any other gathering of people not necessarily of a specific type, assembled with or without a specific purpose.

### BRIEF DESCRIPTION OF FIGURES

FIG. 1 shows interaction only between people known to one another, which is the current scenario.

FIG. 2 shows an embodiment of a scenario of the novel format of interaction with the mark, among people.

FIG. 3 shows an embodiment of the use of the mark, wherein a person totally unknown to the group or the stranger is interacting with the group and the stranger after perceiving, seeing or hearing of, as could be the case with a blind person the use of the mark at a place.

FIG. 4 shows an embodiment of the use of the mark wherein the mark displays interaction among people on one to one basis, showing interactions within the groups shown in the other scenarios too for more detail.

FIG. 5 is an embodiment of authorisation obtained by a user typically an owner of a restaurant or other place to use the mark at his/her premises. The authorisations are depicted at a certain web address also authorised for this purpose. In the embodiment figure place 1 P1 is shown as authorised to place the mark in its location and therefore it is displaying the mark at P1 and people are interacting in the novel format. P2 not authorised and cannot and does not follow this format of interaction.

FIG. 6 is a further embodiment of the use of the mark wherein people's interest to interact or not interact with strangers is depicted and honoured using Yes/No flags at a location authorised to use the mark.

FIG. 7 shows a further embodiment of the use of the mark wherein volunteers or employees at a location talk to people who no one else may want to talk to, at a place displaying the mark.

FIG. 8 shows an embodiment of a scenario of a man getting to know the addresses where such marks are displayed and consequently where the novel format of interaction is practiced. This is done through an authorised website.

### SUMMARY OF INVENTION

The present invention provides is a novel format of the process of interaction between people not necessarily of a specific type, assembled with or without a specific purpose at any location, event through comprising of a sign or mark, the said sign capable of displaying information about this novel format of the process of interaction between people, the said sign:

a. is a logo,

b. is a mark,

c. is a combination of a sign, script and a mark,

d. is an audio clip, or

e. is a pattern in a fluid or gas

the said sign is accessible remotely by communication means facilitating mutual interaction among people for any purpose

Further, the sign is same in all places of assembly of people which are authorised to use this sign.

Further, the sign displayed at any location means that the location entertains, honours, allows, or practices interaction of the people in the new format.

Further, the embodiment of this mark at any event means that the event may entertain, honour, allow, interaction of the people in the new format.

Further, embodiment of the invention may be wherein physical object displaying the sign may be a rigid strong object of regular or irregular geometrical shape, an electronic object, a virtual object. The present invention may be constructed of a rigid or non-rigid material including but not limited to plastic, glass, metal, woven cloth, non-woven cloth, fluid, ceramic, silica, clay, rubber, wood, primary metal, fabricated metal, paper, foam, concrete, fibre, or combinations thereof.

Further, an embodiment of the invention may be wherein the sign on the physical object may be drawn in any natural colour, combinations of colours to provide the novel format of the invention.

In yet another embodiment of the invention is wherein the physical object displaying the sign may be an electronic display to provide the novel format of the invention.

Still further, an embodiment of the invention may be wherein the remote accessibility of the sign may be by—log in of a web site.

A further embodiment of the present invention may be that the mark may be accessed by users registered to access remotely.

An embodiment of the invention may be wherein the remote accessibility of the sign may be by a user through accessing a web site.

Embodiment of the present invention may be wherein the user registered may be an individual, an owner of a location who wants to display this sign on his location.

An embodiment of the invention may be such wherein a mark indicating and thus capable of implementation of this format of interaction among people can be any or a combination of

a. an announcement
b. an advertisement
c. invitation to attract people to interact
d. a verbal message
e. a sign language message
f. a visual message
g. colours, script, figures, symbols, numbers
h. through living beings, animals, trees
i. any matter, vacuum, or energy
j. any kind of message, letter
k. mails, electronic messages,
l. by virtue of a specific location, an event
m. a type of construction
n. a way of invitation.

However, all these such embodiments of the mark and the mark talked about in this invention document are part of this invention only if they depict, or indicate or represent the use of this novel format of the process of interaction between people at restaurants, events or any other gathering of people not necessarily of a specific type, assembled with or without a specific purpose.

### DETAILED DESCRIPTION

The present invention facilitates people to meet any type of people who may or may not be affiliated to any cast, creed, race, ethnicity, geographical location, religion or whatever and who are known or unknown to them. The invention further is not limited to use of high value gadgets or communication means of the present day. The basic format of the interaction between people is that any interested party when comes across a mark which indicates this novel format of interaction, will know of and can use and will be using the opportunity to interact with people or group of people known or unknown to them.

The mark may be any symbol, logo or a literal representation but not limited to any, say plastic, painted on a wall. The mark may be printed on banners or electronic display boards without any limitations to these media. Without any limitation, the mark may be hosted on a web site for people to access the mark and use it for the intended benefit. To gain information about locations of the mark, an intending user can access the web site offering the access to the mark and authorised to do so. The web site lists all the authorised places around the world where the mark is placed and the user may easily find the exact location of the mark depending on his her choice of place of congregation of people. Places where people normally gather will be required to register themselves with the web site by which they will have the facility to display the mark and the location of the place where the mark is hosted. The mark may be displayed at any location worldwide and can be accessed for its location by an authorised web site. The access to the mark is preferably authenticated by a registration process but is not limited to it. The access to use the mark must be authorised.

Those places which are not authorised will not get the facility of display of their locations on the website and the mark on their location. This will preclude them from using the mark. And since the mark is mandatory for using the novel format of the process of interaction between people at restaurants, events or any other gathering of people not necessarily of a specific type, assembled with or without a specific purpose, that place cannot use the novel format of the process of interaction between people at restaurants, events or any other gathering of people not necessarily of a specific type, assembled with or without a specific purpose.

The mark may be hoisted in any place of gathering like restaurants, airports, community halls, malls, hospitals, cinema halls, and railway stations of any type, without any limitation to any geographical location or type of location other than said locations with authorisation to display it.

The mark may be accessed remotely a priori for the benefit of the people and used for their intended benefit. The accessibility to a mark is not restricted to just marks on any electronically displayed system. Information about any mark on any physical medium may be accessed remotely by any communication means.

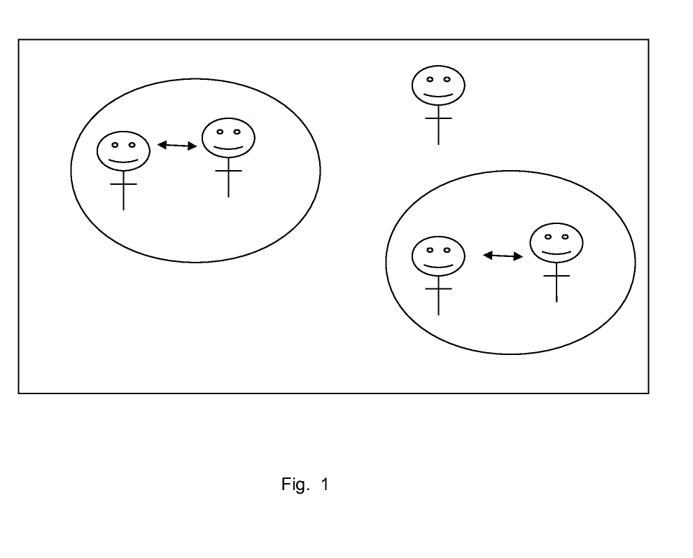

A representative embodiment of the format of interaction of present invention is shown in the figures ahead. In FIG. 1 ls depicted the current situation at a place where people meet. There are groups of people who are known to each other as shown by the circles and there are people who do not have groups, or do not know anyone at that place, or whom no one at this place knows. The place is shown by the rectangle. Here, the stranger doesn't talk to anyone, and no one talks to this stranger or to people in other groups. Basically at any place where people meet, people rarely can gather the courage or overcome social barriers to talk to people who they do not know. Please note that in all the figures the symbols and their meanings are the same.

A rectangle means a location/event etc. A circle with stick figures inside mean groups of people known to each other. A stick figure is the one that looks like a person and means a person. Hard lined Arrows represent communication and the directions of the arrows represent directions of the communication flow.

More elements are described as they appear.

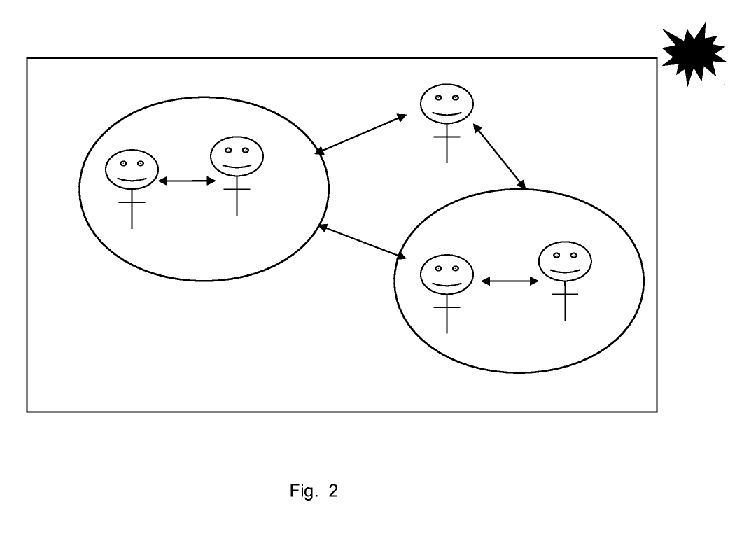

FIG. 2 depicts a shaded star shape, used here just as an example embodiment of the mark, on the top right corner outside the rectangle. This means that the location displays the mark described above. This can and would have been done by authorisation to display this mark. Now the stranger may be an individual or a group, that is outside of any group already present, having seen the mark displayed on this location, understands that in this location everyone is open to and allowed to approach strangers for conversation. So the individual/group can now interact with the groups. The groups already present, in turn, also know of this novel format of interaction being followed at this location and can go ahead and talk to the stranger and also to the other groups. The mark depicts the novel format of the process of interaction between people at restaurants, events or any other gathering of people not necessarily a specific type, assembled with or without a specific purpose described in this document where the novel process is interaction of people known and unknown to each other which is not common otherwise unless because of a particular reason or in special circumstances. This novel process would mean that everyone will feel free to and get opportunities to interact with strangers as a greatly known and common way of social and informational interaction. And also if people want, can become widely available. Many problems that arise out of talking to strangers being so uncommon will disappear, like lack of friends, or people to talk to or people to give information about local tastes, culture etc. wherever one goes. Many psychological diseases might disappear which are caused by people not being able to reach out to other human beings. Thus this mark indicates this novel format where people are free to and can interact with strangers and the strangers also welcome such interaction. Use of this mark is prohibited in the format of the interaction for any other unauthorised purposes.

Also note that in these figures no place where such interactions with strangers are taking place does not have the shaded star shape (the example mark used here) outside the top right corner here. This means that no place without the mark will be authorised to use, or honour or entertain this novel format of interaction. The placing of the shaded star shape in these figures on the outside of the top right corner in the figures corresponds to display of the mark at a location authorised to using the mark.

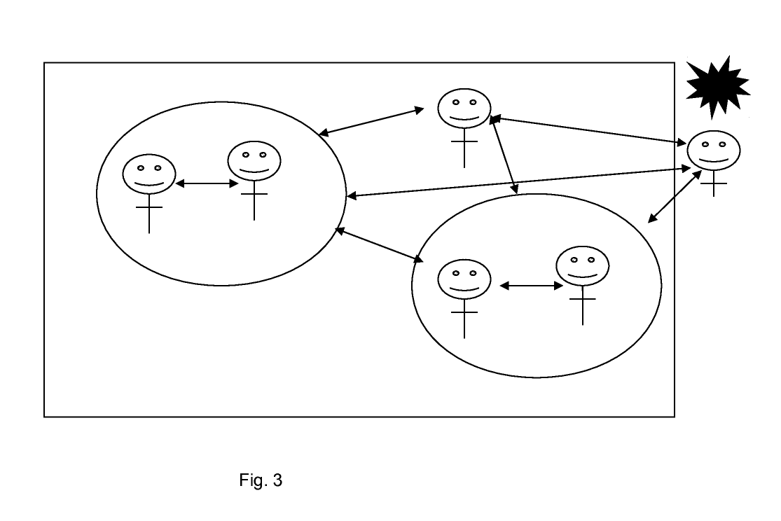

FIG. 3 shows a further description of the format of interaction of the present invention. In this, the mark depicts another stranger coming to this location, seeing the mark or hearing of it, in case of blind people, understanding that the novel format of interaction is being followed at that place, goes and talks to any of the people in the groups or someone not in any group.

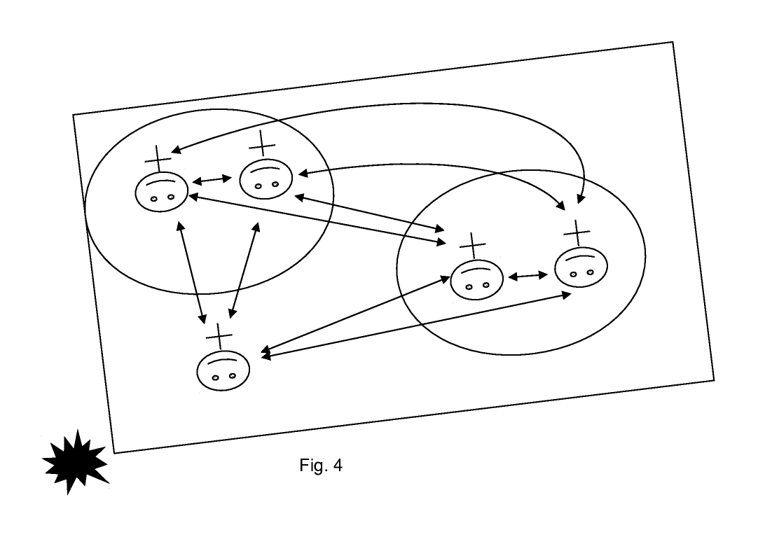

FIG. 4 shows the actual scenario described more in detail where the stranger interacting with the group might actually be interacting with one or more members of the group.

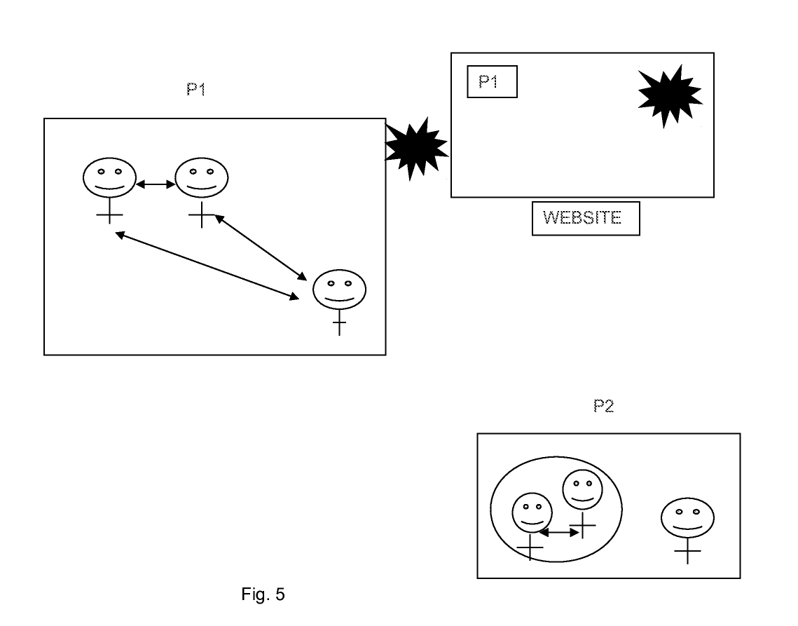

FIG. 5 shows an exemplary embodiment of the web based representation of authorisation to use the mark. Two places P1 and P2 exist, for example. One is authorised to use the mark P1 and is depicted as such in the website authorised by the person who authorises locations to use the mark to represent the authorisation relations on the web. Thus location P1 uses the novel format of interaction between people and P2 is not shown to be authorised to use this mark, so people at this place P2 do not use this format of interaction.

Please note that authorisations mentioned all over or anywhere in this document, are meant to be the right of the inventor.

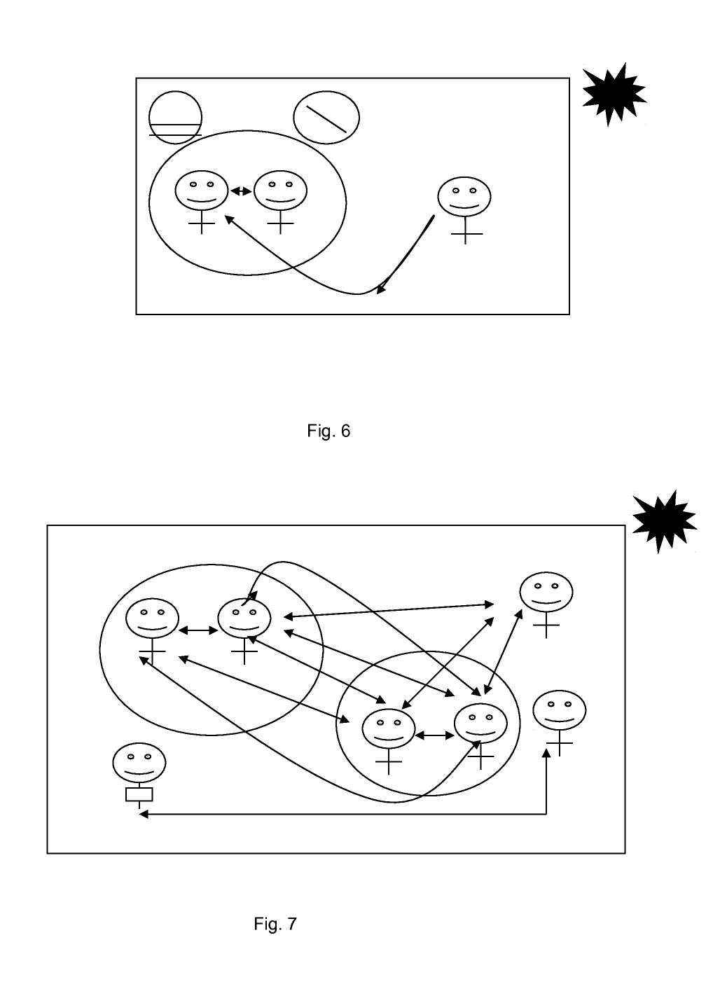

FIG. 6 depicts that many a times even if a person comes across the mark inviting him to interact, the person may not want to, temporarily or otherwise to interact to strangers at this place. To help such a person, the owners of the location using this mark can provide and announce the use of two flags, a YES and a NO flag. The actual design of these flags may be decided by the particular place or later may be centralised in another possible embodiment of this invention.

A person displaying a YES flag means to invite strangers to talk to him or her. That is, a person displaying a YES flag is open to stranger interaction.

While, a person displaying a NO flag means that he or she doesn't want strangers to talk to him or her. That is, a person displaying a NO flag is not open to stranger interaction. However, the absence of a flag would mean YES. Hence with the use of such flags, one can ensure that stranger interaction is safe, controlled and is available whenever one desires and is not forced upon people who might not want to interact with strangers, or may just want to watch such interactions around them. Also, here, as depicted in the figure, the flags might or might not apply to people already known to a person. This would be based on the discretion of the person showing the flag. Also, a person with a YES or NO flag cannot go to a person with a NO flag. A person with a YES can go to a YES. It would be not intended obviously for a person with a NO flag to interact with a YES one, but such matters would mean to be solved by the place.

Here the YES flag is shown to be a small circle filled with double horizontal lines. The NO flag is shown in the figures by a small circle with a single slanted line.

In another embodiment of use, as in FIG. 7 people may have a preference to interact with a specific type of people and exclude all other types. In such a scenario a person can remain lonely for a long period of time even though the person wants to interact with strangers. In such an event the place hosting such a mark of social interaction may like to help the person. This may be accomplished by appointing a group of people who will interact as “all time friends” and will basically go and talk to such people who no one is there to talk to. This is shown in FIG. 7 wherein the person who is the facilitator, here, the stick figure wearing a box, is available to talk to people who have no one else to talk to.

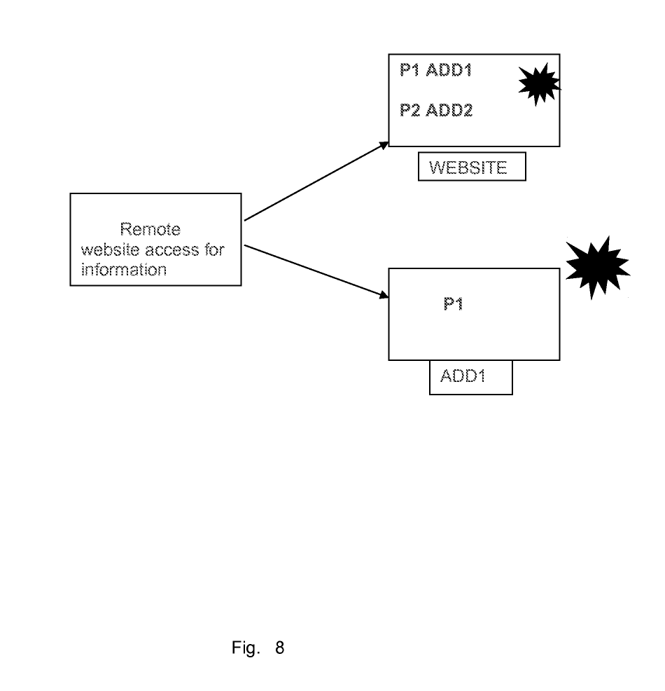

FIG. 8 shows a communication means particularly but not limited to a mobile device wherein a person can locate the addresses of authorised places P1 or P2 both of which in this figure are shown to be in displayed as places authorised to use the mark in this invention. Thus any person can locate which places are available which allow such interaction and can choose to go there. Further, a place with one name or owning organisation can have many addresses, all of which may not be authorised and for different amounts of time. All these details decide what will actually be displayed against the name of the place but the scenario of this figure where people can know the locations and times of the authorised places will remain.

The novelty of the invention lies in the mark which displays the facilitation of meeting people or group of people in any place of gathering by means of a logo, symbol or a script or any combination of any or all of these. The inventive step in realising the novelty of the invention is in mandatory compliance to honour the mark when the mark is placed in any location and a place not displaying the mark cannot honour the format of meeting of people with or without any purpose. A further inventive step is that the mark introduces a new format of useful interaction between people.
1. The mark as discussed all over or anywhere in this document is under the purview of the claimed mark only if it depicts, indicates, or represents the use of the novel format of interaction part of this invention.
2. Authorisations mentioned all over or anywhere in this document, are meant to be the right of the inventor

Following examples are given for illustrative purposes only and should not be construed to limit the scope of this invention.

### Example 1

A person travels to Japan from India and checks out of immigration and customs clearance at Narita Airport. When he alights from escalator he sees a mark depicting an arrow towards a lounge. The mark which is a white rectangle on a signboard which says “Talking to All” this being an example authorised mark in use to depict this invention in this example. The person goes to this place and talks to people and gets help and other benefits of interaction. He gets the required help.

The advantages of the present invention are:
1. Uses a simple mark to assist people to interact.
2. Does not need necessarily any high tech electronic gadgets or communication means.
3. Is capable of facilitating people interaction with one another unknown to them. They can talk to strangers wherever the mark is displayed in any premises.
4. The invention format can be used in any conceivable situation or location, existing, planned or unplanned.

I claim:

1. A process of facilitating the interaction between people not necessarily of a specific type, assembled with or without a specific purpose at any location or event, comprising:
a. a sign selected from the group comprising a logo, a mark, a combination of a sign, script and a mark, an audio clip, or a pattern in a fluid, or combinations thereof and
wherein said sign is capable of displaying information to facilitate the process of interaction between people, and is optionally accessible remotely by communication means, said sign facilitates mutual interaction among people for any purpose.

2. The process of facilitating the interaction between people of claim 1, wherein said sign is the same in all places of assembly of people which are authorised to use the sign.

3. The process of facilitating the interaction between people claim 1, wherein the locations displaying the mark entertains, honours and allows interaction of people.

4. The process of facilitating the interaction between people of claim 1, wherein the events displaying the mark entertains, honours and allows interaction of the people.

5. The process of facilitating the interaction between people of claim 1, wherein said sign is constructed of a material selected from the group comprising, plastic, glass, metal, woven cloth, non-woven cloth, fluid, ceramic, silica, clay, rubber, wood, primary metal, fabricated metal, paper, foam, concrete, fibre, or combinations thereof.

6. The process of facilitating the interaction between people of claim 1, wherein the shape of said sign may of any regular or irregular geometrical shape.

7. The process of facilitating the interaction between people of claim 1, wherein said sign may be an electrical object.

8. The process of facilitating the interaction between people of claim 1, may be a virtual object.

9. The process of facilitating the interaction between people of claim 1, wherein said sign is an electronic display.

10. The process of facilitating the interaction between people of claim 9, wherein said electronic display is animated.

11. The process of facilitating the interaction between people of claim 9, wherein said electronic display is non-animated.

12. The process of facilitating the interaction between people of claim 1, further comprising said remote accessibility is established by logging into a website by a user.

13. The process of facilitating the interaction between people of claim 1, further comprising said remote accessibility is established by logging into a website by a user.

14. The process of facilitating the interaction between people of claim 13, wherein said user is a registered or unregistered user of said website.

15. A process of facilitating the interaction between people not necessarily of a specific type, assembled with or without a specific purpose at any location or event, comprising:
a. a sign selected from the group comprising a logo, a mark, a combination of a sign, script and a mark, an audio clip, or a pattern in a fluid, and
wherein said sign is capable of displaying information to facilitate the process of interaction between people, and is optionally accessible remotely by communication means, said sign is capable of being used by mutual interaction among people for any purpose.

16. The process of claim 15, wherein said mark is capable of implementating the facilitation of interaction among people by means comprising
a. an announcement;
b. an advertisement;
c. a method to attract people to interact;
d. a verbal message;
e. a sign language message;
f. a visual messages;
g. colours, script, figures, symbols, numbers;
h. through living beings, animals, trees;
i. any matter, vacuum or energy;
j. any kind of message, letter;
k. mails, electronic messages;
l. by virtue of a specific location, an event;
m. of a type of construction; or
n. a way of invitation.

17. A method of generating customers at an eatery, comprising a step of:
advertising said eatery as being designated as place to start and have conversations with strangers;
wherein at least a portion of said conversations are unpremeditated.

18. The method of claim 17, wherein at least two strangers, sitting at adjacent tables, talk to each other as a direct result of being at said eatery designated for having conversations with strangers.

19. The method of claim 17, wherein each stranger of said strangers are charged a fee for eating at said eatery.
